(19) United States
(12) Patent Application Publication
(10) Pub. No.: US 2009/0133332 A1
(43) Pub. Date: May 28, 2009

(54) OPENING DEVICE FOR A FACADE ELEMENT

(75) Inventor: Kurt Peter Nielsen, Toreby (DK)

Correspondence Address: FOLEY AND LARDNER LLP;SUITE 500, 3000 K STREET NW, WASHINGTON, DC, 20007, US

(73) Assignee: Rettighedsselskabet af 13/12 2007 ApS

(21) Appl. No.: 12/067,261

(22) PCT Filed: Sep. 20, 2006
(86) PCT No.: PCT/DK06/50043

§ 371 Date: Jun. 16, 2008

(30) Foreign Application Priority Data
Sep. 20, 2005 (DK) PA 2005 01306

(51) Int. Cl. E04D 13/035; E05F 15/02

(52) U.S. Cl. 49/195; 49/137

(57) ABSTRACT

A device and a method for opening a pivotable façade element both for everyday comfort ventilation purposes and for emergency opening in the case of e.g. fire. The device comprises a rigid frame part pivotable about a centre of rotation displaced from the centre of rotation of the pivotable façade element. The rigid frame part is moved by an actuator providing a lifting force to a contact surface of the façade element, thereby pivoting the façade element. The device also comprises a shock absorber. A release mechanism and a method of releasing a façade element is also disclosed.

The present invention relates to a device for opening a pivotable façade element, especially a skylight or a dome-shaped window that needs to be emergency opened in case of e.g. fire. The invention further relates to a façade element and a method for opening it. The invention further relates to a release mechanism and a method for releasing a façade element in the case of an emergency.

### BACKGROUND OF THE INVENTION

In known constructions for opening pivotable façade elements, especially skylights and dome-shaped windows, it is usually necessary to include some sort of automatic actuation means for opening the window for comfort ventilation since these types of elements are often out of reach of manual handling. Many types of automatic actuation means have been suggested, the most common being the use of a “remote controlled” actuator having one part fixed to the frame of the element and applying a pushing force to the openable part of the element with an extendable part.

In the known constructions of this type the length of stroke of the actuator is limited since it will otherwise obstruct the space underneath the element, making it cumbersome to pass below it as well as taking up space and being an unaesthetic solution. The stroke length of such actuators is therefore typically limited which in turn means that the element can only be opened to a limited angle. A limited stroke length may be sufficient for opening the façade element for everyday comfort ventilation purposes but will not suffice for opening the façade element fully in an emergency situation, e.g. in the event of fire. It is required by today's building standards that a façade element may be fully opened in an easy and quick manner in order to create a passageway for dangerous smoke fumes and/or flue gases.

Also, if an emergency should arise in a building having a pivotable façade element of one of the known constructions during a period of heavy snowfall or strong winds, a significantly powerful actuator will be needed in order to open the element according to the prescribed standards due to a possible heavy load on the façade element surface.

In DE 33 38 092 a dome window opening and closing installation is disclosed. The installation comprises a lever element pivotally connected at a first end thereof to a first side of an inner frame of the dome window and also pivotally connected at a second end to a link element, which in turn is pivotally connected to a raising element (such as a piston). A further damper element is also pivotally connected to the link element. The raising element is pivotally connected at its opposite end to a cross bar near the opposite side of the inner frame of the dome window. The cross bar substantially spans the width of the dome window between opposite inner frame sides. This is necessary for the purpose of maintaining stability and for reinforcing and strengthening the structure of the installation, particularly the dome.

With the installation disclosed in DE 33 38 092 adequate space is required “below” the vertical extent of the dome structure for the lever, link, damper and raising elements. These elements therefore poke into the air below the dome structure occupying valuable building space. If the installation needs to be fully opened, such as in the event of fire, the lever, link, damper and raising elements will at least partly be covering or “concealing” the opening in an inconvenient or even potentially dangerous manner by not allowing for an unhindered passage through the opening.

Also, the cross bar extending across the width of the window underneath the dome as well as the above-mentioned need for space for the different elements of the installation, leaves the installation according to DE 33 38 092 with a less aesthetic appearance.

Thus, there is a need for an improved device for opening of elements such as dome windows, in which the actual opening elements and/or any structure reinforcing members may be hidden or placed in a practical position, respectively avoided. Furthermore, there is a need for an opening device being able to operate even large façade elements that can be exposed to heavy loads with less force and smaller actuation elements, such as cylinders with smaller stroke length.

### DESCRIPTION OF THE INVENTION

It is an object of the present invention to provide an opening device for a pivotable façade element wherein the limitations with regard to stroke length and positioning of the actuator are eliminated and wherein the pivotable façade element is able to open both for everyday comfort ventilation purposes and in the case of fire in the building.

It is a further object of the present invention to provide an opening device for a pivotable façade element wherein the actuator force needed for opening the element is kept at a minimum.

It is another object of the present invention to provide an opening device for a pivotable façade element that does not go beyond the vertical or horizontal extent of the façade element and its frame parts.

It is yet another object of the present invention to provide an opening device for a pivotable façade element wherein no parts cover the element opening in the case of an emergency.

It is yet another object of the present invention to provide an opening device for a pivotable façade element having an improved aesthetic appearance.

It is yet a further object of the present invention to provide a release mechanism for a pivotable façade element facilitating an automatic, mechanic unlocking of the façade element in case of the need for an emergency opening.

It is a still further object of the present invention to provide a pivotable façade element openable by using an opening device.

It is a still further object of the present invention to provide a method for opening a pivotable façade element by using an opening device.

It is a still further object of the present invention to provide a method for opening a pivotable façade element by using an opening device wherein the centre of rotation of the opening device is displaced from the centre of rotation of the façade element.

In a first aspect of the present invention, the disadvantages of the known constructions described above are overcome by providing a device for opening a pivotable façade element comprising:
a rigid frame part having a proximal and a distal end and the frame part having a first side with a proximal and a distal end and a second side with a proximal and a distal end, said proximal end of the second side being joined to or integral with the first side at a substantially right angle thereto,
an actuator pivotally connected to an inner frame part of the façade element and pivotally connected to the distal end of the first side of the rigid frame part,
wherein the rigid frame part is pivotally connected to an inner frame part of the façade element at the proximal end of said rigid frame part, and
the distal end of the rigid frame part abuts a contact surface of the pivotable façade element.

The rigid frame part of the device comprises a first side with a proximal and a distal end and a second side also having a proximal and a distal end. The first and the second sides are preferably at a substantially right angle to each other. In this application the term “distal end” should be interpreted as the end of a member farthest away from the centre of rotation of the rigid frame part, and the term “proximal end” should be interpreted as the end of a member closest to the centre of rotation of the rigid frame part.

The device further comprises an actuator which actuator is pivotally connected to an inner frame part of the façade element. The actuator is also pivotally connected to the distal end of the first side of the rigid frame part. Such pivot connections or joints may be provided as small protrusions on the exterior of the actuator engaging with small apertures in the edges of the sides of the rigid frame part or as any other suitable means for establishing a pivot joint. Bearings of any suitable kind may be provided for the pivotal connections.

The rigid frame part is also pivotally connected to an inner frame part of the façade element. The pivot joint is preferably, but not exclusively, placed in the proximal end of the first side of the rigid frame element. The inner frame part of the façade element may be provided with suitable means for establishing the pivot connection with the proximal end of the rigid frame part.

The distal end of the rigid frame part abuts a contact surface of the pivotable façade element. The contact surface of the element may be one of the sides of a plate-like metal element fixedly connected along at least one edge of the pivotable façade element. In this application, the term “plate-like metal element” should not exclude that the contact surface may comprise bends, neck-ins, flanges, corrugations, apertures, indentations, holes or the like.

The material used for the side of the rigid frame part is typically steel, but it may be any kind of material suitable for meeting the strength requirements of the opening device and may be chosen from any group of materials, e.g. metal, plastic, PVC etc.

In an embodiment the rigid frame part comprises a third side. The third side may preferably, but not exclusively, connect the first and the second sides of the rigid frame part. Particularly, but not exclusively, the third side connects the first and second sides at substantially the proximal end of the first side and substantially the distal end of the second side. The third side of the rigid frame part may preferably, but not exclusively, abut a contact surface of the pivotable façade element. The proximal end of the third side may be pivotally connected to the inner frame part of the façade element.

In an embodiment, the third side of the rigid frame part abuts a contact surface of the façade element.

In a specific embodiment according to the first aspect of the invention the rigid frame part is pivotally connected to a bracket part at the proximal end of the first side of the rigid frame part, the bracket part having a first and a second end and being fixed to the inner frame part of the façade element.

The bracket part may be pre-mounted to the rigid frame part and the actuator thereby making the entire structure (i.e. rigid frame part, bracket and actuator) easy to handle and more stabile. In this way it can be easily fitted into existing façade elements and handling during transportation will also be improved.

In this embodiment the bracket part provides a mounting base facilitating easier connection of the pivot joints of the rigid frame part and/or of the actuator to the element. The bracket part may be made ready beforehand for being fixed to the inner frame part of the façade element, e.g. by providing mounting holes etc., and it will therefore not be necessary to provide the inner frame part with individual mounting means for each pivot joint.

In yet another specific embodiment according to the first aspect of the invention the sides of the rigid frame part are U-shaped profiles. By using U-profiles as material for the sides of the rigid frame part it is possible to reduce the weight of the rigid frame part while still maintaining the required strength and furthermore it will be possible to contain and conceal other parts of the construction within the profile's U-shape.

In a further specific embodiment according to the first aspect of the invention the device comprises a shock absorber element having a first and a second end with the first end being pivotally connected to the rigid frame part and with the second end being pivotally connected to the contact surface of the pivotable façade element.

The first end of the shock absorber element is pivotally connected to the rigid frame part. The second end of the shock absorber element may be pivotally connected to the contact surface of the pivotable façade element by any suitable means.

In further specific embodiments according to the first aspect of the invention the shock absorber element may be a hydraulic or pneumatic piston, a gas cylinder, a coil spring or a link or any other suitable absorbing means.

In a further specific embodiment according to the first aspect of the invention the shock absorber element in a disengaged state is concealed within a side of the rigid frame part. In this way the shock absorber element may be positioned “within” the side of the frame part, i.e. concealed when the façade element is closed and the shock absorber thus not extended. By using U-profiles for the sides of the rigid frame part this is made particularly easy.

In a further specific embodiment according to the first aspect of the invention the device comprises a releasable lock mechanism that is connected to the pivotable façade element. The mechanism has a biased member engaging a retaining device connected to the inner frame part of the façade element. The biased member is releasable from its engagement with the retaining device by lifting action of the rigid frame part provided by the actuator.

In a further specific embodiment according to the first aspect of the invention the releasable lock mechanism comprises

a plate-like contact surface element fixed to the façade element along at least one edge thereof and having a first and a second side and at least two holes therein;
a substantially L-shaped, spring-loaded ratchet element with a long leg of the L-shaped element being slidably positioned in guides on the first side of said surface element and with a short leg of the substantially L-shaped element extending through one of said holes in said surface element;
a protruding part integral with the second side of said surface element and extending in a direction away from said second side of said surface element, and
an end part of said long leg of the L-shaped element engaging the retaining device protruding through a second hole of said surface element.

In this embodiment the releasable lock mechanism comprises a plate-like contact surface element fixed to the façade element along at least one edge thereof. The contact surface is preferably fixed along two edges of the façade element, i.e. in a corner position of the façade element. The plate-like contact surface element has a first and a second side and at least two holes therein. As mentioned, the contact surface may be shaped to fit the requirements for any kind of individual façade element.

On the first side of the contact surface are guides for guiding a substantially L-shaped ratchet element. The long leg of the ratchet element may slide along the guides. The short leg of the ratchet element extends through a hole in the contact surface. In the normal situation the ratchet is brought into engagement with a retaining device that protrudes through another hole in the contact surface. A protruding part integral with the second side of the surface element extends in a direction away from the second side of the surface element. The ratchet element is constantly drawn in a direction towards the retaining device by a spring that may e.g. be attached to the long leg of the ratchet element and to the first side of the contact surface. Other mechanisms for drawing the ratchet element towards the retaining device may also be applied.

In yet another specific embodiment according to the first aspect of the invention the device further comprises a separate opening mechanism for everyday comfort ventilation with an actuator being fixed to the inner frame part of the pivotable façade element where the actuator is driving an extension arm that engages the contact surface of the pivotable façade element.

The actuator for driving the extension arm of the separate opening mechanism may be any suitable means but is preferably an electromotor. The extension arm protrudes through a hole in the contact surface and is kept in engagement with a releasable lock mechanism for release of the façade element according to the invention.

In yet another specific embodiment according to the first aspect of the invention the retaining device is the extension arm of the separate opening mechanism.

If the façade element is not equipped with a separate opening mechanism a fitting fixed to the inner frame part of the façade element may be provided. The fitting comprises an elongated bar protruding through a hole in the contact surface thereby providing the necessary engagement for the ratchet element in order to keep the window locked during normal conditions.

Hence, in another specific embodiment according to the first aspect of the invention the retaining device is an elongated bar integral with a fitting fixed to the inner frame part of the façade element and having a rounded or conical head.

By providing the elongated bar with a rounded or conical head, the elongated bar will slide through the hole in the contact surface when the façade element is closed again after comfort ventilation.

In the normal situation the pivotable façade element is opened for everyday comfort ventilation either by use of the rigid frame part being actuated or by the separate opening mechanism according to the invention.

Hence, in the normal situation the long leg of the L-shaped ratchet element is in constant engagement with the either the extension arm of the separate opening mechanism or with the elongated bar integral with the fitting. This is provided by means of the ratchet element being biased towards the extension arm.

In the case of an emergency where the façade element has to be opened fully, an element, e.g. a hydraulic cylinder or any other type of actuation means, can be pressed into engagement with the short leg of the L-shaped element and the protruding part, in a direction towards the second side of the surface element. Thereby, the L-shaped ratchet element is drawn in a direction away from the retaining device and thereby releasing it from its engagement therewith. Once released, the pivotable façade element is free to open by pivoting around its own individual centre of rotation displaced from the centre of rotation of the opening device.

When the device is actuated, the distal end of the side of the rigid frame part engages the contact surface of the façade element as the device begins to rotate about its pivot joint. The distal end of the side of the frame part engages the short leg of the slidable L-shaped ratchet while simultaneously engaging the protruding part whereby the L-shaped ratchet element is drawn in a direction away from the retaining device thereby releasing it from its engagement therewith.

In yet another specific embodiment according to the first aspect of the invention the rigid frame part further comprises one or more members connecting the first, second and/or third sides. The member(s) may be of the same material as the sides of the rigid frame part. Thereby the rigid frame part of the opening device may be so constructed that it provides a framework or lattice construction with any suitable construction. This may preferably be applied in the case of the opening of a very large façade element or if the façade element is likely to be exposed to very large loads. The rigid frame part may therefore be both a two-dimensional and a three-dimensional structure.

The pivotable façade element may of course be opened for everyday comfort ventilation purposes by either the lifting force from the rigid frame part applied by the main actuator or by the actuator of the separate opening mechanism. Preferably, however, the separate opening mechanism is used for the everyday comfort ventilation.

When the façade element is opened for everyday comfort ventilation by activating the actuator of the separate opening mechanism, the shock absorber element extends simultaneously. When the extension arm of the opening mechanism is fully expanded for comfort ventilation the shock absorber element provides an extra hold of the façade element against possible damage caused by strong winds.

The device according to the first aspect may be installed with any kind of orientation but is preferably installed with a horizontal or vertical orientation.

The device according to the first aspect may be built into a separate box attachable along the inner frame part of the façade element or it may be incorporated directly in the inner frame part of the façade element. In this manner the device will be concealed whenever the façade element is closed thus improving aesthetics.

In a second aspect of the present invention, the disadvantages of the known constructions described above are overcome by providing a method of opening a pivotable façade element with a device according to the first aspect of the invention wherein
the pivotable façade element pivots around a pivot joint displaced from a pivot joint of the rigid frame part by actuation of the actuator whereby the distal end of the rigid frame part transfers the force from the actuator to the contact surface of the façade element thereby providing a lifting force and causing the façade element to pivot about its pivot joint and the retaining device to be released from its engagement with the biased member.

By pivotally connecting the actuator to the distal end of the first side of the rigid frame part and by further letting the actuator be pivotally connected to the inner frame part of the façade element, a force will be transferred from the distal end of the rigid frame part to the contact surface of the façade element when the actuator is actuated. By making a distance between the point of application of the force from the actuator and the pivot joint of the rigid frame part, this distance acts as a moment arm. Hence, the force needed from the actuator is dependent on the length of the distance between the point of application of the force from the actuator and the pivot joint of the rigid frame part, which means that the longer the distance, the smaller the actuator force needed to provide the lifting force at the contact surface of the façade element.

By providing the method according to the second aspect of the invention it is further possible to allow the pivot joints (i.e. the centres of rotation) of the pivotable façade element itself and of the rigid frame part, to be displaced with respect to each other. The opening of the façade element is therefore possible over two centres of rotation, which in turn means that the force and the required stroke length needed to open the façade element is reduced by the method according to the second aspect of the invention.

In a specific embodiment according to the second aspect of the invention the shock absorber element pivotally connected to a side of the rigid frame part and to the contact surface of the façade element engages at a position where gravity pulls the façade element backwards in the pivoting direction thereby absorbing shock.

During the pivoting of the façade element the shock absorber connected to the side of the rigid frame part and to the contact surface of the façade element will engage at a position where gravity pulls the façade element backwards in the pivoting direction. The shock absorber will thus absorb the shock that this force would otherwise have inflicted on the device.

The extended shock absorber further facilitates opening of the façade element beyond the possible angle provided by the fully extended actuator. Depending on the different dimensions of the pivotable façade element, various sizes and types of shock absorbers may be utilized and may be positioned at any suitable position along a side of the rigid frame part.

In a third aspect of the present invention, the disadvantages of the known constructions described above are overcome by providing a pivotable façade element having at least one device according to a first aspect of the invention
wherein the pivotable façade element pivots around a pivot joint displaced from the pivot joint of the rigid frame part by actuation of the actuator whereby the distal end of the rigid frame part transfers the force from the actuator to the contact surface of the façade element thereby providing a lifting force and causing the façade element to pivot about its pivot joint.

The pivotable façade element may be equipped with one or more devices according to the first aspect of the invention. Preferably the number of devices is two per façade element. Furthermore, any number of façade elements may be provided and installed next to each other and their actuators being either individually or commonly actuated.

In specific embodiments according to the third aspect of the invention the pivotable façade element is a vertical window, a door, a skylight or a dome-shaped window.

The pivotable façade element may be any type of window, door, gate or the like, preferably a skylight such as dome-shaped windows or convex windows or plane windows or pyramidal windows or double-inclined windows/skylights, and the windows comprise single-layer or multi-layer windows, such as windows with two layers or three layers, and the layers of the multi-layer windows may be separated by air spaces.

### DESCRIPTION OF THE FIGURES

Preferred embodiments of the invention will now be described in details with reference to the accompanying drawing, in which:

FIG. 1 is a side view of a skylight shown in its fully opened position and with dotted lines showing the skylight in its closed position,

FIG. 2 is a side view of a skylight shown in its closed position with an opening device and a separate opening mechanism,

FIG. 3 is an enlarged, sectional view of a release mechanism taken along the line B-B in FIG. 2,

FIG. 4 is a side view of a skylight shown in its closed position with an opening device but without the separate opening mechanism,

FIG. 5 is an enlarged, sectional view of a release mechanism taken along the line A-A in FIG. 4,

FIG. 5a is a plan view of the release mechanism of FIG. 3 or 5 seen from above,

FIG. 5b is a plan view of the release mechanism of FIG. 3 or 5 seen from below,

FIG. 6 is a side view of the skylight of FIG. 2 shown in the position open for everyday comfort ventilation,

FIG. 7 is an enlarged side view of the detail indicated with a box in FIG. 6,

FIG. 8 is a side view of a skylight in a position being released from its engagement and before being fully opened,

FIG. 9 is a side view of a skylight with an inclined inner frame part.

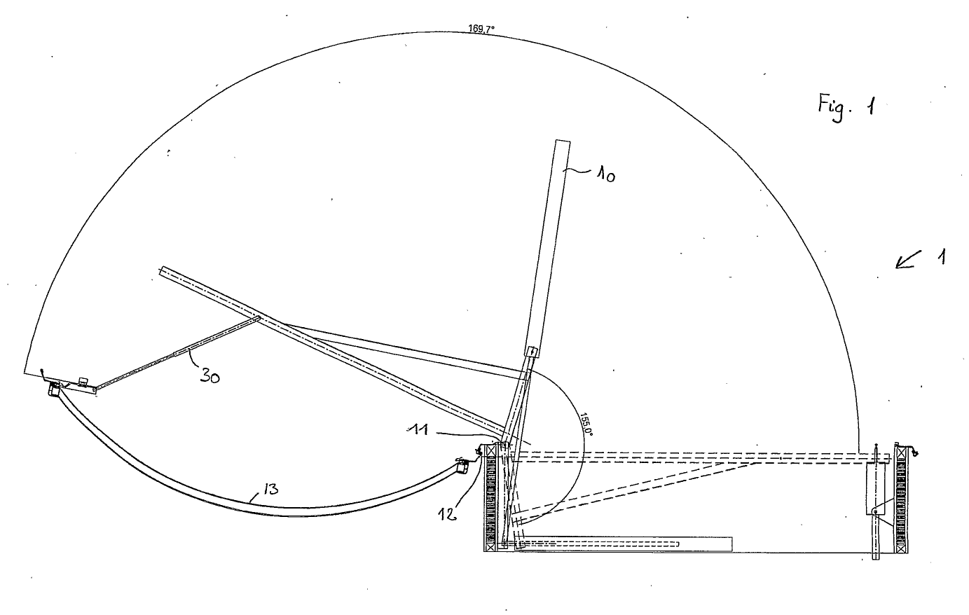

FIG. 1 shows a fully opened pivotable façade element, in this example a skylight (1), and the opening device (2) according to the invention. The figure illustrates how the skylight rotates about its individual pivot joint (12) whenever the actuator (10) is activated and making the device turn about its own individual, pivot joint (11) displaced relative to the pivot joint (12) of the window part (13) of the skylight (1). The dotted lines indicate how the device (2) is positioned when the skylight (1) is in its closed position. The figure further illustrates how the shock absorber (30) is extended when the skylight (1) is fully opened thereby facilitating a substantially increased angle of rotation of the window part (13) of the skylight (1).

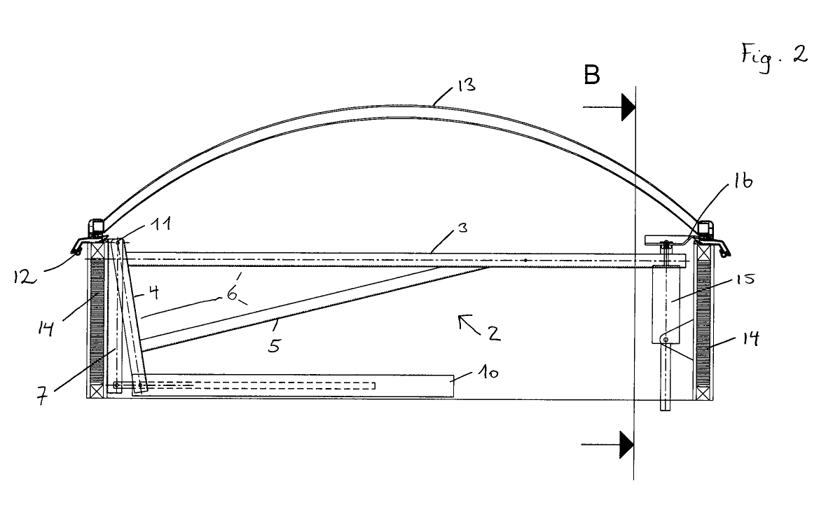

FIG. 2 shows a skylight (1) with an opening device (2) comprising a rigid frame part (6) having a first side (4), a second side (5) and a third side (3) being connected e.g. by welding. Also shown is the bracket part (7) being attached to the inner frame part (14) of the skylight (1). The individual centres of rotation (11, 12) of the device (2) and the window part (13) of the skylight are also indicated as well as the actuator (10). The point of application of the force provided by the actuator (10) in FIG. 2 is at the distal end of the first side (4) of the rigid frame part (6). Depending on the length of the side (4) the force needed from the actuator (10) may be larger or smaller depending on whether the distance is decreased or increased since the side (4) in this case acts a moment arm. The resulting force supplied by the actuator (10) is a lifting force at the point where the distal end of the side of the rigid frame part engages with the contact surface (16) of the skylight (1). A separate opening mechanism by means of an electromotor (15) can be provided for opening the skylight (1) for everyday comfort ventilation.

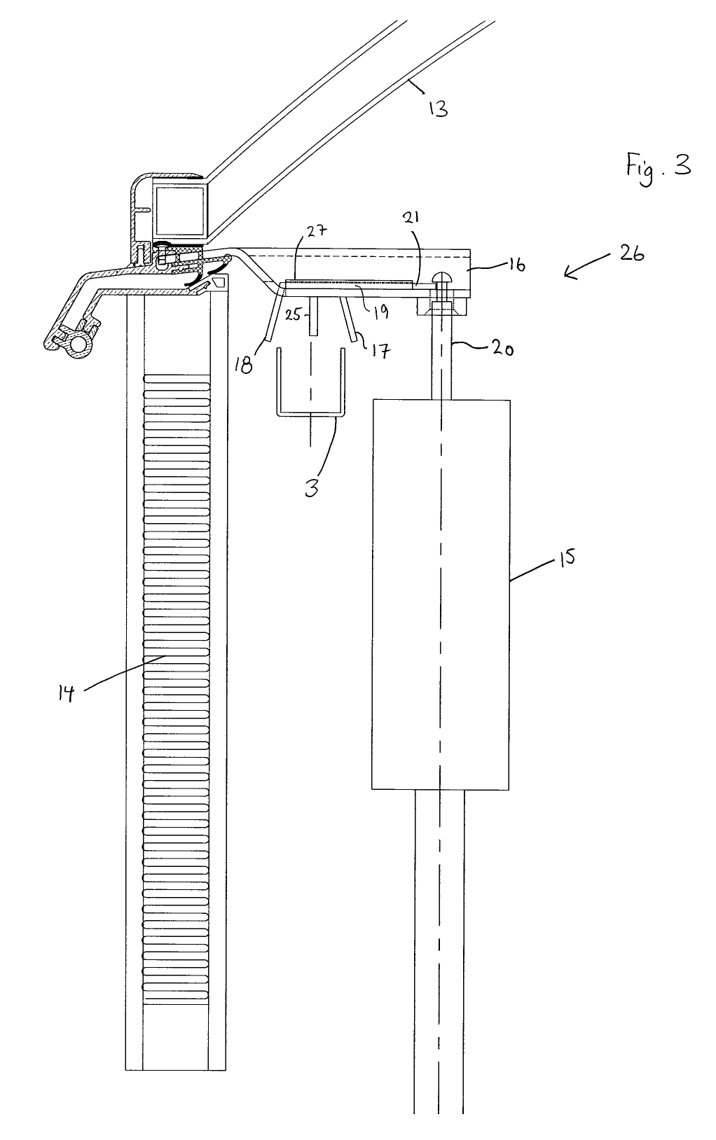

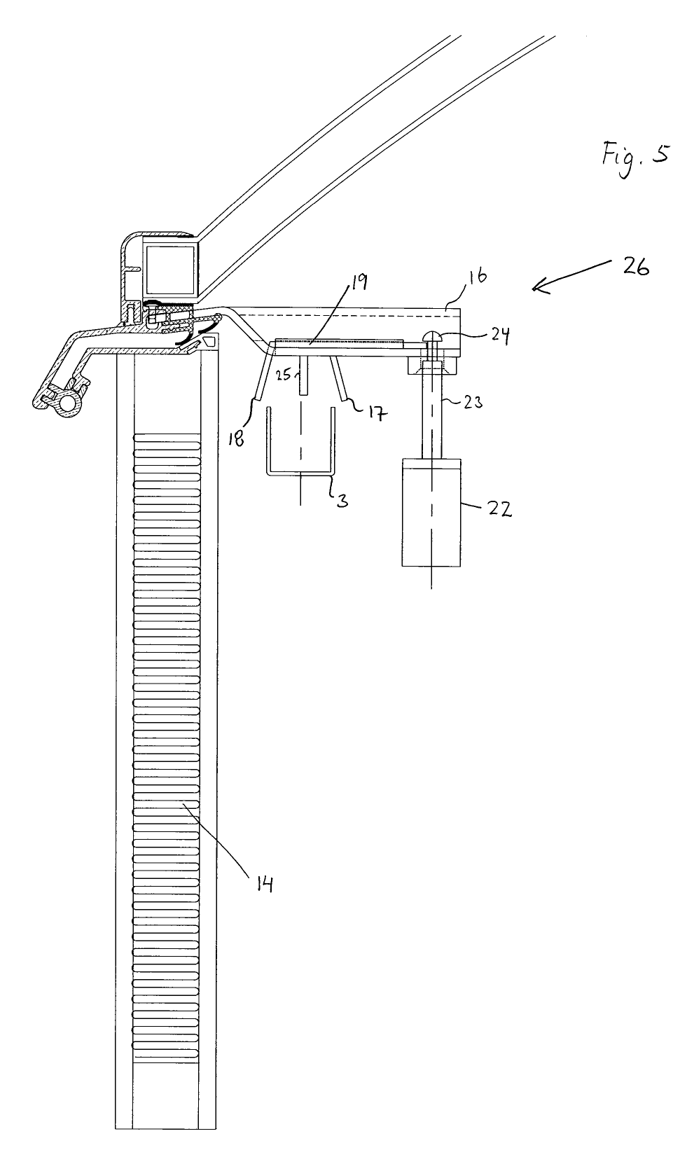

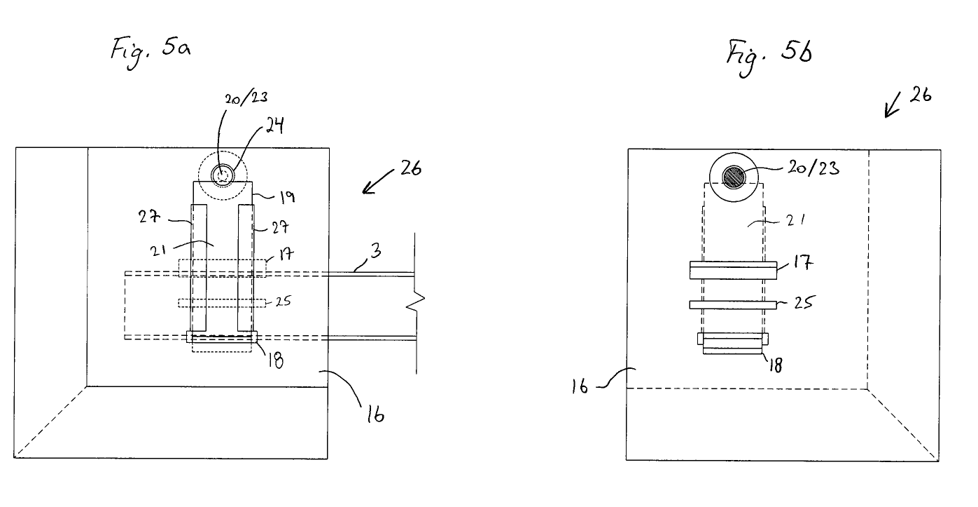

FIG. 3 shows an embodiment of the invention wherein a separate opening mechanism is provided for opening the window part of the skylight (13) for everyday comfort ventilation. The separate opening mechanism comprises an electromotor (15) having a linear extendable extension arm (20). The opening mechanism is attached to the inner frame part (14) of the skylight (1) by means of a fitting (not shown). The figure also shows how the extension arm (20) of the electromotor (15) protrudes through the contact surface (16) of the skylight (1) and is in locking engagement with the long leg (19) of the ratchet element (21). The long leg (19) is guided by means of guide rails (27), best seen in FIG. 5a. It is also shown how the short leg (18) of the ratchet element (21) protrudes through another hole in the contact surface (16) where it is substantially opposite to the protruding part (17) integral with the surface (16). During normal conditions, the skylight (1) is opened by activation of the electromotor (15), which causes the extension arm (20) engaged with leg (19) to push the contact surface (16) in an upward direction. If, however, the skylight (1) needs to be opened due to an emergency the main actuator (10) is actuated whereby the distal end of the side (3) of the rigid frame part (6) is lifted. This causes the side (3) to engage with the short leg (18) and the protruding part (17). Thereby the short leg (18) of the ratchet element (21) is drawn in a direction away from the extension arm (20) of the electromotor (15) whereby the skylight (1) is released.

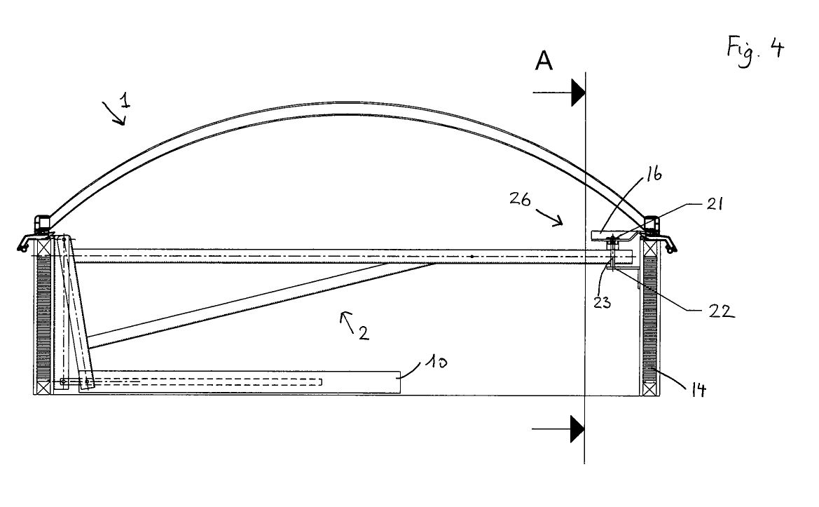

FIG. 4 shows a skylight (1) with a releasable lock mechanism (26) but without a separate opening mechanism (15, 20). Instead of having the separate opening mechanism the skylight (1) is in this embodiment opened by the opening device (2) both for everyday comfort ventilation and in the event of an emergency. When the skylight (1) is closed, the long leg (19) of the ratchet element (21) is in engagement with an elongated bar (23) integral with a fitting (22) fixed to the inner frame part (14) of the skylight (1). When the skylight (1) needs to be opened for comfort ventilation or due to an emergency the main actuator (10) is actuated whereby the distal end of the side (3) of the rigid frame part (6) is lifted. This causes the side (3) to engage with the short leg (18) and the protruding part (17). Thereby the short leg (18) of the ratchet element (21) is drawn in a direction away from the elongated bar (23) of the fitting (22) whereby the skylight (1) is released. By providing the elongated bar (23) with a rounded or conical head (24), best seen in FIG. 5, the bar (23) will slide through the hole in the contact surface (16) when the skylight (1) is closed again after comfort ventilation.

FIG. 5 is a sectional view of the embodiment in FIG. 4, which shows how the releasable lock mechanism (26) engages with the elongated bar (23) of the fitting (22) instead of engaging with the extension arm (20) of the electromotor (15). The figure also shows how the elongated bar (23) has a rounded or conical head (24) needed for guiding the bar (23) through the hole in the contact surface (16) when the skylight (1) needs to be closed again after comfort ventilation.

FIG. 5a is plan view seen from above of the releasable lock mechanism (26) showing in more detail how the ratchet element (21) has a long leg (19) being guided in guide rails (27) and engaging either the extension arm (20) of the electromotor (15) or the elongated bar (23) of the fitting (22) depending on the construction. The figure also shows the short leg (18) of the ratchet element (21) extending through the contact surface (16) to a position where it may engage with the side (3) of the rigid frame part (6) when this is actuated by the force of actuator (10).

FIG. 5b is a plan view similar to FIG. 5a, but showing the releasable lock mechanism (26) from below. Aside from the short leg (18) of the ratchet element (21), this figure also shows the protruding part (17) integral with the contact surface (16) and the small protrusion (25) positioned between the protruding part (17) and the short leg (18) which protrusion (25) is used for attachment of the second end of the shock absorber element (30).

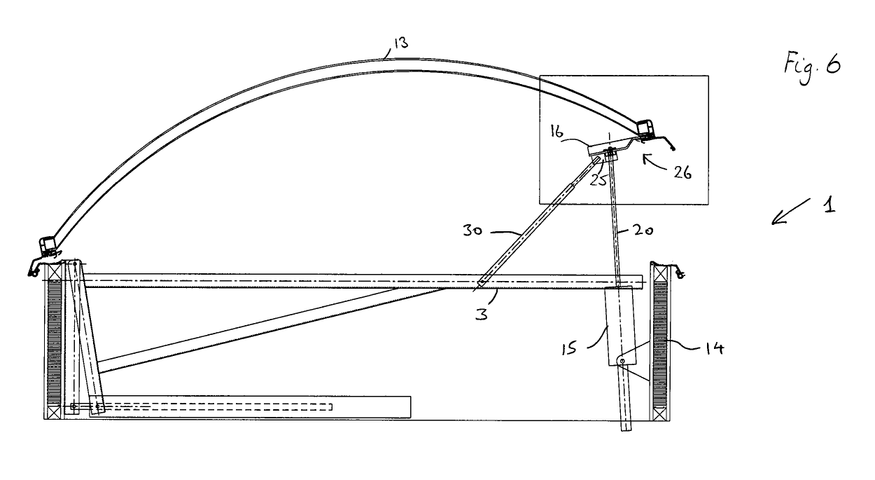

FIG. 6 shows the embodiment of FIG. 2, but with the skylight (1) opened for comfort ventilation by means of the electromotor (15) extending the extension arm (20). The figure also shows the releasable lock mechanism (26) and how the shock absorber element (30), pivotally connected to both the first side (3) of the rigid frame part (6) and to the contact surface (16), is extended due to the lifting of the window part (13) of the skylight (1). The small protrusion (25) with a through-going hole is provided at the second side of the contact surface (16) for the pivotal connection with the shock absorber element (30). In the situation for comfort ventilation, the shock absorber (30) contributes to stabilisation and/or lifting of the device in the event of e.g. bad weather conditions such as strong winds or snowfall. It is further noticeable how the shock absorber (30) is folded and thereby concealed in the first side (3) when the skylight (1) is closed. Also, if the skylight (1) is emergency opened the shock absorber (30) will only extend when the opening angle of the skylight (1) exceeds the point where gravity causes the skylight (1) to tip backwards, thereby absorbing the shock that this would otherwise cause. This extension of the shock absorber (30) also means that the skylight can be opened at a larger angle than possible if the extendable shock absorber (30) is not provided (see FIG. 1).

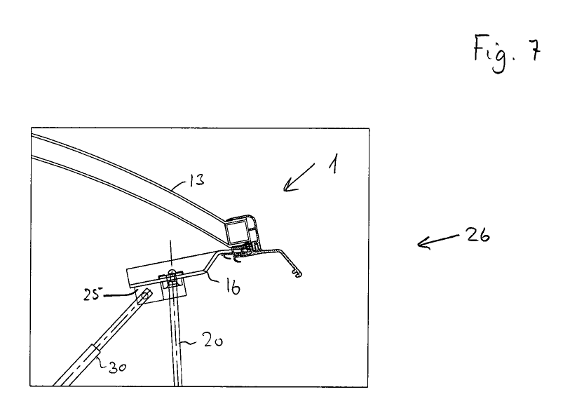

FIG. 7 is an enlarged side view of the releasable lock mechanism (26) showing the connections between the shock absorber element (30), the small protrusion (25), the extension arm (20) of the electromotor (15), and the contact surface (16) of the skylight (1). By positioning the small protrusion (25) between the short leg (18) of the ratchet element (21) and the protruding part (17), it is ensured that the shock absorber (30) is concealed in the first side (3) of the rigid frame part (6) when the skylight (1) is closed or when it needs to be emergency opened.

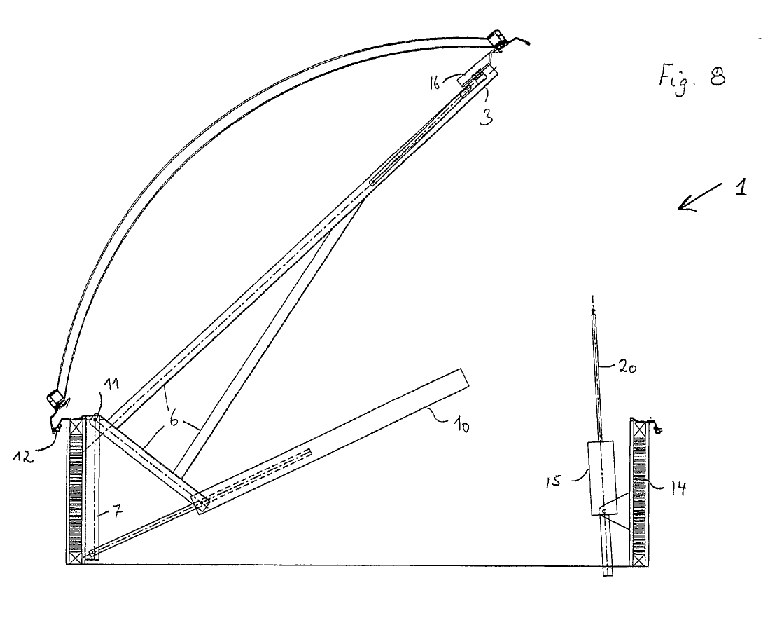

FIG. 8 is a view of a skylight corresponding to the embodiment shown in FIGS. 1 and 2, however in a situation where the skylight is released from the releasable lock mechanism (26) due to an emergency. The side (3) of the rigid frame part (6) abuts the contact surface (16) of the skylight where it transfers the lifting force provided by actuation of the actuator (10). In this figure it is particularly noticeable how the skylight is opened by applying a force to the inner frame part (14) of the skylight on the “opposite” side of where the skylight is opened. It is further important to notice that the centre of rotation (12) of the façade element (1) is displaced relative to the centre of rotation (11) of the rigid frame part (6). If the rigid frame part is a lattice construction wherein the sides of the rigid frame part are connected by one or more members, the rigid frame part has two or more connections, i.e. pivot joints (11) around which it rotates.

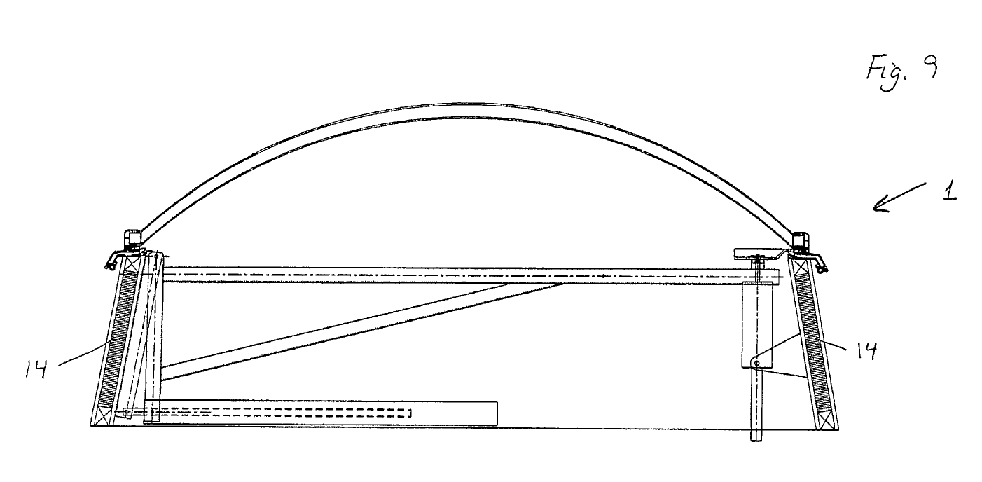

FIG. 9 is a view of a skylight shown with an inclined inner frame part (14). Other inclinations or constructions of the inner frame part may be used and is also covered by this application.

| Reference number | Feature |
|---|---|
| 1 | Pivotable façade element |
| 2 | Opening device |
| 3 | Third side |
| 4 | First side |
| 5 | Second side |
| 6 | Rigid frame part |
| 7 | Bracket part |
| 10 | Main actuator |
| 11 | Centre of rotation, rigid frame part |
| 12 | Centre of rotation, façade element |
| 13 | Window part |
| 14 | Inner frame part of façade element |
| 15 | Actuator |
| 16 | Contact surface |
| 17 | Protruding part |
| 18 | Short leg of ratchet element |
| 19 | Long leg of ratchet element |
| 20 | Extension arm of electromotor |
| 21 | Ratchet element |
| 22 | Fitting |
| 23 | Elongated bar of fitting |
| 24 | Rounded/conical head of elongated bar |
| 25 | Small protrusion |
| 26 | Releasable lock mechanism |
| 27 | Guide rails |
| 30 | Shock absorber element |

1-18. (canceled)

19. A device (2) for opening a pivotable façade element (1) comprising
a rigid frame part (6) having a proximal and a distal end said frame part having a first side (4) with a proximal and a distal end and a second side (5) with a proximal and a distal end, said proximal end of the second side being joined to or integral with the first side (4) at a substantially right angle thereto,
an actuator (10) pivotally connected to an inner frame part (14) of the façade element (1) and pivotally connected to the distal end of said first side (4) of the rigid frame part (6) whereby the actuator force engages the inner frame part (14) of the façade element (1) and said rigid frame part substantially at the proximal end of the rigid frame part (6), and
wherein the rigid frame part (6) is pivotally connected to the inner frame part (14) of the façade element (1) at the proximal end of the first side (4) of said rigid frame part (6), and
the distal end of the rigid frame part (6) abuts a contact surface (16) of the pivotable façade element (1).

20. A device (2) according to claim 19 wherein the rigid frame part (6) further comprises a third side (3) with a proximal and a distal end.

21. A device (2) according to claim 20 wherein the distal end of the third side (3) abuts a contact surface (16) of the pivotable façade element (1).

22. A device (2) according to claim 19 wherein the rigid frame part (6) is pivotally connected to a bracket part (7) at the proximal end of said first side (4) of the rigid frame part (6), said bracket part (7) having a first and a second end and being fixed to the inner frame part (14) of the façade element (1).

23. A device (2) according to claim 19 wherein the sides (3, 4, 5) of the rigid frame part (6) are U-shaped profiles.

24. A device (2) according to claim 19 and further comprising a shock absorber element (30) having a first and a second end, said first end being pivotally connected to the rigid frame part (6) and said second end being pivotally connected to the contact surface (16) of the pivotable façade element (1).

25. A device (2) according to claim 24 wherein the shock absorber element (30) is a hydraulic or pneumatic piston, a gas cylinder, a coil spring or a link.

26. A device (2) according to claim 24 wherein the shock absorber element (30) in a disengaged state is concealed within a side of the rigid frame part (6).

27. A device (2) according to claim 19 wherein a releasable lock mechanism (26) is connected to the façade element (1) having a biased member engaging a retaining device connected to the inner frame part (14) of the façade element (1) and being releasable from its engagement with the retaining device by the lifting action of the rigid frame part (6).

28. A device (2) according to claim 27 wherein the releasable lock mechanism (26) comprises
a plate-like contact surface element (16) fixed to the façade element (1) along at least one edge thereof and having a first and a second side and at least two holes therein;
a substantially L-shaped, spring-loaded ratchet element (21) with a long leg (19) of the L-shaped element being slidably positioned in guides on the first side of said surface element (16) and with a short leg (18) of the substantially L-shaped element (21) extending through one of said holes in said surface element (16);
a protruding part (17) integral with the second side of said surface element (16) and extending in a direction away from said second side of said surface element (16), and
an end part of said long leg (19) of the L-shaped element (21) engaging the retaining device protruding through a second hole of said surface element (16).

29. A device (2) according to claim 19 further comprising a separate opening mechanism for everyday comfort ventilation with an actuator (15) being fixed to the inner frame part (14) of the pivotable façade element (1) said actuator (15) driving an extension arm (20) engaging the contact surface (16) of the pivotable façade element (1).

30. A device (2) according to claim 29 wherein the retaining device is the extension arm (20) of the separate opening mechanism (15, 20).

31. A device (2) according to claim 28 wherein the retaining device is an elongated bar (23) integral with a fitting (22) fixed to the inner frame part (14) of the façade element (1) and having a rounded or conical head (24).

32. A device (2) according to claim 19 wherein the rigid frame part (6) further comprises one or more members connecting said sides (3, 4, 5).

33. A method of opening a pivotable façade element (1) with the device (2) according to claim 19 wherein
the pivotable façade element (1) pivots around a pivot joint (12) displaced from a pivot joint (11) of the rigid frame part (6) by actuation of the actuator (10) whereby the distal end of the rigid frame part (6) transfers the force from the actuator (10) to the contact surface (16) of the façade element (1) thereby providing a lifting force and causing the façade element (1) to pivot about its pivot joint (12) and the retaining device (20, 23) to be released from its engagement with the biased member.

34. A method according to claim 33 wherein the shock absorber element (30) pivotally connected to a side of the rigid frame part (6) and to the contact surface (16) of the façade element (1) engages at a position where gravity pulls the façade element (1) backwards in the pivoting direction thereby absorbing shock.

35. A pivotable façade element (1) having at least one device (2) according to claim 19 wherein
the pivotable façade element (1) pivots around a pivot joint (12) displaced from the pivot joint (11) of the rigid frame part (6) by actuation of the actuator (10) whereby the distal end of the rigid frame part (6) transfers the force from the actuator (10) to the contact surface (16) of the façade element (1) thereby providing a lifting force and causing the façade element (1) to pivot about its pivot joint (12).

36. A pivotable façade element (1) according to claim 35 wherein the element is a vertical window, a door, a skylight or a dome-shaped window.
